(19) United States
(12) Patent Application Publication
(10) Pub. No.: US 2017/0079889 A1
(43) Pub. Date: Mar. 23, 2017

(54) A MOUTHPIECE FOR AN INFANT FEEDING VESSEL

(71) Applicant: KONINKLIJE PHILIPS N.V., EINDHOVEN (NL)

(72) Inventors: MARIJN KESSELS, EINDHOVEN (NL); COEN JANSEN, EINDHOVEN (NL)

(73) Assignee: KONINKLIJKE PHILIPS N.V., EINDHOVEN (NL)

(21) Appl. No.: 15/312,199

(22) PCT Filed: May 7, 2015
(86) PCT No.: PCT/EP2015/060007

§ 371 Date: Nov. 18, 2016

(30) Foreign Application Priority Data
May 20, 2014 (EP) 14169152.7

(51) Int. Cl. A61J 11/02; A61J 11/04

(52) U.S. Cl. CPC A61J 11/02; A61J 11/045

(57) ABSTRACT

The present application relates to a mouthpiece (20) for an infant feeding vessel (10). The vessel (10) has a mounting collar (60) configured to be received between a receptacle (30) for holding fluid and a connector (40) for mounting the mouthpiece (20) to the receptacle (30) when assembled. The vessel (10) also has an air valve (70) in the mounting collar (60) to allow the flow of air into the receptacle (30) when the mouthpiece (20) is mounted to the receptacle (30). The air valve is biased towards an open condition in its un-assembled state. At least part of the mounting collar (60) is resilient and is configured to be received between the receptacle (30) and the connector (40) when assembled. The at least part of the mounting collar (60) that is resilient is deformable to act on the air valve (70) to tend the air valve (70) towards a closed or further closed condition when the at least part of the mounting collar (60) that is resilient is compressed between the receptacle (30) and the connector (40) and in turn urged to deform in an inwardly radial direction of the mounting collar.

### FIELD OF THE INVENTION

The present application relates to a mouthpiece for an infant feeding vessel. The present application also relates to an infant feeding vessel including a mouthpiece.

### BACKGROUND OF THE INVENTION

Infant feeding vessels are known to aid infants with feeding. Such feeding vessels generally have a teat, a container for holding fluid and a fastening ring for fixedly mounting the teat to the container. A fluid seal is formed between the teat and the container to prevent leakage.

It is known to incorporate an air valve in the teat to allow air to enter the container while the infant is feeding to restrict the creation of a vacuum in the container. However, the provision of an air valve in the teat may is known to cause leakage. Furthermore, teats are generally formed of a soft resilient material. However, during assembly of the feeding vessel forces are applied to the bottle which can cause the teat to distend and so cause the air valve to leak or increase leakage. If a user attempts to further tighten the fastening ring to reduce leakage then further distension and leakage may occur.

GB 2 066 795 A discloses a feeding bottle teat which comprises a valve defined by a single main linear cut passing through the centre of the teat top and two lateral cuts extending perpendicularly from the main cut, the lateral cuts being offset in opposite directions from the centre.

### SUMMARY OF THE INVENTION

It is an object of the invention to provide a mouthpiece for an infant feeding vessel and/or an infant feeding vessel including a mouthpiece which substantially alleviates or overcomes the problems mentioned above, among others.

The invention is defined by the independent claims; the dependent claims define advantageous embodiments.

According to the present invention, there is provided a mouthpiece for an infant feeding vessel comprising a mounting collar configured to be received between a receptacle for holding fluid and a connector for mounting the mouthpiece to the receptacle when assembled, and an air valve in the mounting collar to allow the flow of air into the receptacle when the mouthpiece is mounted to the receptacle, wherein the air valve is biased towards an open condition in its unassembled state, wherein at least part of the mounting collar is resilient and is configured to be received between the receptacle and the connector when assembled, the at least part of the mounting collar that is resilient being deformable to act on the air valve to tend the air valve towards a closed or further closed condition when the at least part of the mounting collar that is resilient is compressed between the receptacle and the connector and in turn urged to deform in an inwardly radial direction of the mounting collar.

With this arrangement it is possible to ensure that leakage from the air valve can be minimised or prevented. Furthermore, a straightforward means of ensuring that the air valve is more effective when the mouthpiece is assembled in an infant feeding vessel is achieved.

The air valve may have an elongate opening extending perpendicular or substantially perpendicular to a radial line of the mouthpiece.

This helps to prevent deformation of the air valve due to closing forces applied to the mouthpiece and so restricts leakage from the air valve. Furthermore, with this arrangement leakage due to shear forces applied to the fastening ring in a circumferential direction is restricted.

The elongate aperture may extend at an angle of greater than 80 degrees to a radial line of the mouthpiece.

The air valve may be a slit. Therefore, the air valve is easily formed. The direction of closing of the air valve may be easily determined.

The air valve may be biased towards an open condition.

With this arrangement, the air valve is prevented from becoming stuck in a closed position when the mouthpiece is disassembled from other components.

The air valve may be a duckbill valve.

The mounting collar may be resilient. With such an arrangement, the whole mounting collar is resilient. This means that the mounting collar is easily formed, and the air valve may be simply formed in the mounting collar.

Material of the at least part of the mounting collar that is resilient may be configured to distend in a transverse direction to the direction of compression when the at least part of the mounting collar that is resilient is compressed between the receptacle and the connector.

With this arrangement, it is possible to simply provide an urging force on the air valve to urge the air valve to close or further close.

Material of the at least part of the mounting collar that is resilient may be configured to distend radially inwardly when the at least part of the mounting collar that is resilient is compressed between the receptacle and the connector.

The at least part of the mounting collar that is resilient may be formed from hyper-elastic rubber. This means that the mounting collar may be easily deformed and so an urging force on the air valve may be easily achieved in response to a compressive force on the mounting collar.

The mouthpiece may be a teat. The teat may be for a feeding bottle.

The mouthpiece may be a spout. The spout may be for a toddler feeding cup.

According to another aspect of the present invention, there is provided an infant feeding vessel comprising a receptacle for receiving fluid, a mouthpiece according to any one of claims 1 to 10 and a connector configured to mount the mouthpiece to the receptacle.

With this arrangement, it is possible to provide an infant feeding vessel with an air valve in which leakage through the air valve is restricted. Furthermore, it is possible to provide an air valve in which the closing force applied to the air valve may be easily varied by adjusting the fastening ring.

The connector may be configured to restrict the at least part of the mounting collar that is resilient from distending radially outwardly when the at least part of the mounting collar that is resilient is compressed between the receptacle and the connector.

With this arrangement it is possible to help ensure that the compressive force applied to the fastening ring causes an inwardly directed force to be applied due to the direction in which the at least part of the mounting collar that is resilient is able to deform is restricted.

The receptacle may have an upper end and the connector may have an inner side, wherein the mounting collar may be configured to be received between the upper end of the receptacle and the inner side of the connector during assembly of the infant feeding vessel. The profile of the mounting collar may correspond to the profile of a mounting collar receiving space defined between the upper end of the receptacle and the inner side of the connector during assembly of the infant feeding vessel.

With this arrangement the direction in which material of the mounting collar is able to deform is easily controlled. The mounting collar is restricted from deforming outwardly and so an inwardly orientated radial force is able to be simply applied to the air valve. The connector may be a fastening ring. The connector may be threadingly engagable with the receptacle.

Therefore, the infant feeding vessel is easily assembled. The compression applied to the mounting collar can be controlled.

These and other aspects of the invention will be apparent from and elucidated with reference to the embodiments described hereinafter.

### BRIEF DESCRIPTION OF THE DRAWINGS

Embodiments of the invention will now be described, by way of example only, with reference to the accompanying drawings, in which:

FIG. 1 shows a schematic illustration of a feeding bottle with a teat according to an embodiment of the present invention;

FIG. 2 shows a schematic perspective view of the teat of the feeding bottle shown in FIG. 1;

FIG. 3 shows a schematic cross-sectional view of part of the teat shown in FIG. 2;

FIG. 4 shows a schematic plan view of the teat shown in FIG. 2; and

FIG. 5 shows a schematic cross-sectional view of a spout for a feeding bottle according to another embodiment of the present invention.

### DETAILED DESCRIPTION OF EMBODIMENTS

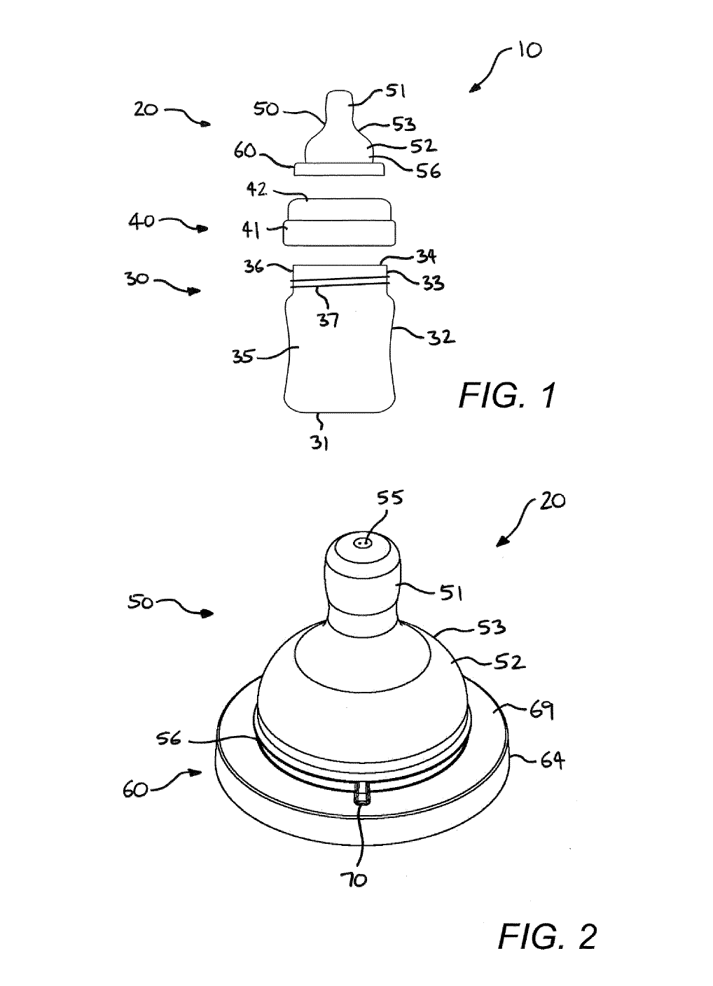

Referring to FIG. 1, a feeding bottle 10 is shown. The feeding bottle 10 acts as an infant feeding vessel. Although the following description describes a feeding bottle, it will be understood that alternative arrangements are possible in which the infant feeding vessel has a different configuration. Any reference to a feeding bottle can be replaced by a reference to an infant feeding vessel. Such an infant feeding vessel is configured to allow an infant to be fed, or to feed itself, with a substance appropriate for an infant, for example breast milk or infant formula.

As used herein, the term “infant feeding vessel” includes vessels for feeding an infant having a mouthpiece such as feeding bottles or toddler feeding cups. The term “infant” relates to a young child, such as a baby or a toddler. The term “mouthpiece” includes, for example, a teat, a spout or a straw. A mouthpiece is a part or portion that may be received in or at an infant's mouth through which a substance, such as a liquid, may be drawn or flow into the infant's mouth.

The feeding bottle 10 comprises a teat 20, a container 30 and a fastening ring 40. The fastening ring 40 is mountable to the container 30 to mount the teat 20 to the container 30.

The teat 20 acts as a mouthpiece for the feeding bottle. Although in the present embodiment the mouthpiece is a teat, it will be appreciated that an alternative arrangement for a mouthpiece may be used, for example a spout or straw. Any reference to a teat can be replaced by a reference to a mouthpiece.

Referring to FIGS. 2 to 4, the teat 20 has a nipple portion 50 and a mounting collar 60. The nipple portion 50 and mounting collar 60 of the teat 20 have a longitudinal axis and are rotationally symmetrical about the longitudinal axis. The nipple portion 50 and mounting collar 60 are integrally formed from a resilient material, such as a suitable rubber or latex material. The material of the mounting collar 60 may be a hyper-elastic rubber. In one embodiment, the nipple portion 50 and mounting collar 60 may be fixedly mounted to each other. In such an embodiment, the nipple portion 50 and mounting collar 60 may be formed from different materials.

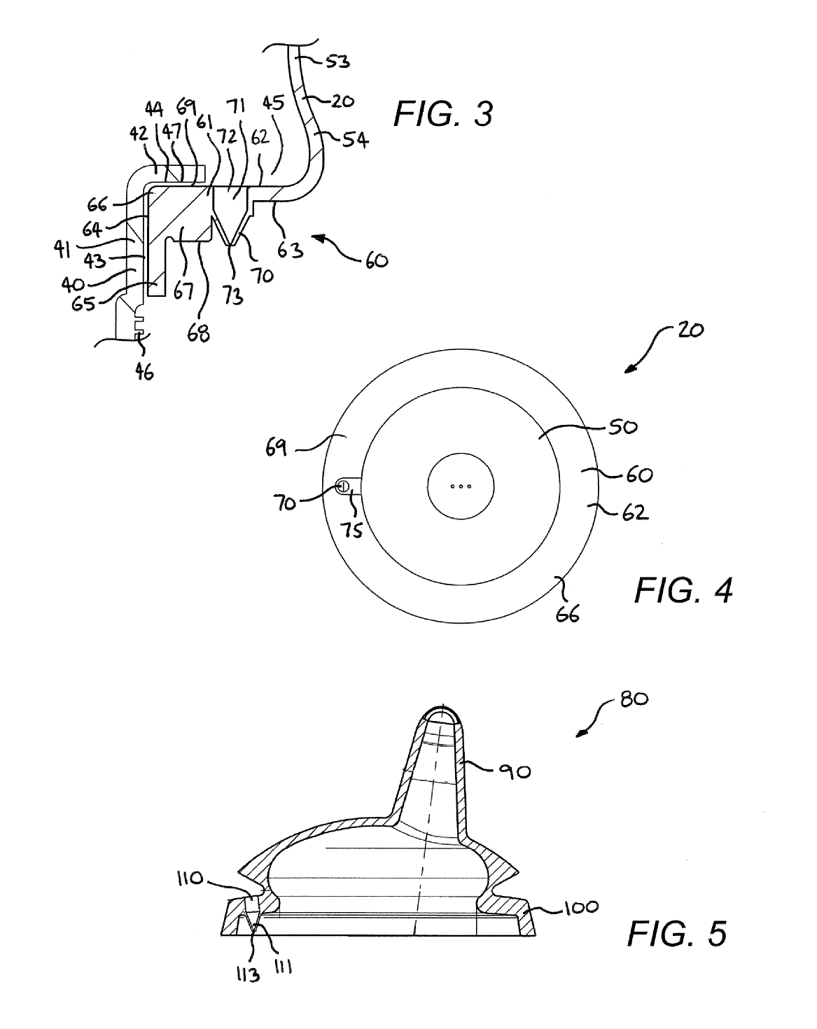

The nipple portion 50 comprises a nipple section 51 and an aerola section 52 which extends from a lower end of the nipple section 51. The nipple portion 50 comprises a rotationally symmetric, resiliently deformable outer wall 53 having an inner face 54 (refer to FIG. 3). The inner face 54 of the outer wall 53 defines a fluid receiving space in which fluid, for example milk, to be expressed from the teat 20 is contained when the container 30 with the teat 20 fixedly mounted thereto is in an inverted position, so that milk flows into the teat.

One or more apertures 55 (refer to FIG. 2) are formed in an upper end of the nipple portion 50 of the teat 20, and the one or more apertures 55 communicates with the fluid receiving space for the flow of milk, in use, from the container 30 to which the teat 20 is to be attached, through the one or more apertures 55, and into a baby's mouth.

Referring in particular to FIG. 3, the mounting collar 60 extends outwardly from the nipple portion 50. The mounting collar 60 extends from a lower end 56 of the nipple portion 50. The mounting collar 60 has an outwardly extending flange section 61. The flange section 61 is rotationally symmetrical about the longitudinal axis. The mounting collar 60 extends circumferentially around the nipple portion 50.

The mounting collar 60 has an upper side 62, a lower side 63 and an end face 64. The upper side 62 and lower face 63 extend substantially parallel to each other. The end face 64 defines the periphery of the mounting collar 60. The mounting collar 60 has a lip 65 extending from an outer end 66 of the flange section 61. The lip 65 is configured to overlap an upper end of the container 30. The lip 65 extends downwardly from the lower side 62. The lip 65 is rotationally symmetrical about the longitudinal axis. The lip 65 extends circumferentially. The lip 65 may be omitted. The outer end 66 has an outer edge 66a. The outer edge 66a has a radius.

The mounting collar 60 has a region of increased wall thickness 67. The region of increased wall thickness 67 extends in a circumferential band around a longitudinal axis of the teat. The region of increased wall thickness 67 is formed on the lower side 63 of the mounting collar 60. The region of increased wall thickness 67 is formed proximal to the outer end 66 of the flange section 61. A container abutting face 68 is defined on the lower side 63 of the mounting collar 60. In the present embodiment, the container abutting face 68 is defined by the region of increased wall thickness 67. However, it will be understood that the region of increased wall thickness 67 may be omitted.

A fastening ring abutting face 69 is defined on the upper side 62 of the mounting collar 60. In the present embodiment, the fastening ring abutting face 69 is defined by an upper side of the region of increased wall thickness 67. The fastening ring abutting face 69 and container abutting face 68 are aligned with each other. That is, they oppose each other to define a circumferential band around the mounting collar 60.

In the present arrangement, the container abutting face 68 and the fastening ring abutting face 69 are planar. However, in an alternative arrangement one or both of the container abutting face 68 and the fastening ring abutting face 69 may have a protruding profile, such as a convex profile.

The teat 20 has an air valve 70. The air valve 70 extends through the teat 20. The air valve 70 communicates through the mounting collar 60 to define an air passage through which air is able to flow when the valve is open. The air valve 70 is a one-way valve. In the present arrangement, the air valve 70 is a duckbill valve.

The air valve 70 has an elongate opening 71. The elongate opening 71 has an inlet 72 and an outlet 73. The elongate opening 71 extends perpendicular to a radial line of the mouthpiece. Although the elongate opening 71 extends perpendicular to a radial line in the present embodiment, it will be understood that the elongate opening 71 may extend transversely to the radial line within a limited range of angles, for example an angle greater than 80 degrees to a radial line of the mouthpiece. That is, the elongate extends at least substantially perpendicular to a radial line of the mouthpiece. In the present embodiment, the outlet 73 is a slit. The air valve 70 has opposing opening edges that abut against each other when the air valve 70 is in a closed condition. The outlet 73 is defined on the lower side 62 of the mounting collar 60. The inlet 72 is defined on the upper side 61 of the mounting collar 60. The air passage of the air valve 70 diverges away from the outlet 73.

The air valve 70 protrudes on the lower side 62 of the mounting collar 60. In the present embodiment, the air valve 70 is disposed adjacent to the region of increased wall thickness 67. The air valve 70 is disposed radially inside of the region of increased wall thickness 67. The inlet 72 is spaced from the fastening ring abutting face 69. Therefore, the air valve 70 is not blocked by the fastening ring 40. The outlet 73 is spaced from the container abutting face 68. Therefore, the air valve 70 is not blocked by the container 30. In one embodiment the air valve 70 is formed in the region of increased wall thickness 67. In such an embodiment, the width of the region of increased wall thickness 67 in the radial direction is greater than the width of the radial dimension of the container abutting face 68 and the fastening ring abutting face 69.

The air valve 70 is resilient. The air valve 70 is configured to return to its normal state when external forces are not applied to the teat 20. The air valve 70 is configured to transition between an open condition and a closed condition. The air valve 70 is configured to transition between its open and closed conditions dependent on external forces applied to it.

In the present embodiment, the air valve 70 is configured to be biased in an open condition in its undeformed state. That is, the air valve 70 is open in its normal unassembled state. An advantage of this arrangement is that the air valve 70 is restricted from becoming sealed closed and so reliability is maximised. In the present embodiment the opening width of the outlet 73 is about 54 microns.

A channel 75 is formed in the upper side 61 of the mounting collar 60. The channel 75 extends from the air valve 70. The channel 75 extends radially inwardly. The channel 75 helps to allow air to flow to the inlet 72 of the air valve 70. Therefore, the fastening ring 40 may extend over the inlet 72, but spaced from the inlet 72 by the channel 75. This may help restrict the air valve 70 from becoming blocked by detritus.

Referring to FIG. 1, the container 30 has a base 31 and a circumferentially extending sidewall 32. The base 31 has a planar surface 32 so that the feeding bottle 10 may be stood upright on a surface, such as a table. The container 30 has a neck 33. The neck 33 is at the upper end of the sidewall 32. The neck 33 and the sidewall 32 are integrally formed. The neck 33 is cylindrical. The neck 33 has an upper face 34. The upper face 34 forms a rim of the container 30. The upper face 34 defines an upper end against which the mouthpiece 20 is locatable. The upper face 34 is planar.

An opening (not shown) is formed through the neck 33 and communicates with a fluid holding space 35 defined by the container 30. The opening is defined by an inner edge of the rim formed by the upper face 34. The neck 33 has a cylindrical side face 36. A helical thread 37 is on the side face 36. The helical thread 37 forms part of an attachment arrangement for attaching the fastening ring 40 to the container 30. The fastening ring 40 has a corresponding helical thread 46.

Referring to FIGS. 1 and 3, the fastening ring 40 has a ring outer wall 41 and a ring upper wall 42. The ring outer wall 41 is cylindrical. The ring outer wall 41 and ring upper wall 42 have a longitudinal axis and are rotationally symmetrical about the longitudinal axis. The ring outer wall 41 has a circumferentially extending inner surface 43. The diameter of the inner surface 43 of the fastening ring 40 corresponds to the diameter of the neck 33 of the container 30 so that the ring outer wall 41 is able to be received over the neck 33. That is fastening ring 40 is able to overlap the neck 33 of the container 30. The helical thread 46 on the fastening ring 40 is on the inner surface 43 of the fastening ring 40 at a lower end. The helical thread 46 on the fastening ring 40 is threadingly engagable with the helical thread 37 on the neck 33 of the bottle 30. Therefore, the fastening ring 40 and bottle 30 are mountable to each other.

The ring upper wall 42 has a lower surface 44. A teat receiving aperture 45 is formed through the ring upper wall 42. The teat receiving aperture 45 is configured to receive the nipple portion 52 of the teat 20 therethrough. Therefore, the nipple portion 52 of the teat 20 is able to extend from the fastening ring 40. The radius of the teat receiving aperture 45 is greater than the radial distance to the air valve 70. The lower surface 44 of the ring upper wall 42 defines a mounting collar urging surface 47. The mounting collar urging surface 47 extends as a circumferentially extending band. The inner surface 43 and lower surface 44 define an inner side of the fastening ring 40.

To assemble the feeding bottle 10, the teat 20 is disposed on the bottle 30. The teat 20 is received on the neck 33 of the bottle 30. The container abutting face 68 of the mounting collar 60 is located against the upper face 34 of the bottle 30. The diameter of the container abutting face 68 corresponds to the upper face 34 of the bottle 30 so that they abut against each other. The lip 65 of the teat 20 overlaps the neck 33 to help locate the teat 20 and to assist with sealing between the bottle 30 and the teat. The radial distance of the air valve 70 from the longitudinal axis is less than the inner radius of upper face 34 of the bottle 30 so that the upper face 34 of the bottle 30 does not obstruct the air valve 70.

The fastening ring 40 is received over the teat 20. The nipple portion 52 of the teat 20 is received through the teat receiving aperture 45. The mounting collar 60 is received between the neck 33 of the bottle 30 and the fastening ring 40. The upper end of the bottle 30 and inner side of the fastening ring 40 together define a mounting collar receiving space when brought together. The flange section 61 is received between the ring upper wall 42 and the upper face 34 of the bottle 30. That is, the region of increased wall thickness 67 is received between the mounting collar urging surface 47 of the fastening ring 40 and the upper face 34 of the bottle 30.

The ring outer wall 41 is received over the lip 65 of the teat 20 and overlaps the neck of the bottle 30. The fastening ring 40 and the bottle 30 are rotated relative to each other about their longitudinal axis so that the corresponding helical threads 37, 46 of the fastening ring 40 and neck 33 of the bottle 30 threadingly engage with each other.

As the fastening ring 40 and the bottle 30 are rotated relative to each other to engage with each other, the fastening ring 40 is drawn towards the container 30. That is, the mounting collar urging surface 47 of the fastening ring 40 and the upper face 34 of the bottle 30 are drawn towards each other. The mounting collar urging surface 47 of the fastening ring 40 locates against the fastening ring abutting face 69 of the mounting collar 60.

The diameter of the inner surface 43 of the fastening ring 40 corresponds to the diameter of the end face 64 of the mounting collar 60. The profile of the mounting collar receiving space defined by the upper end of the bottle 30 and inner side of the fastening ring 40 corresponds to the profile of at least the outer end of the mounting collar 60. Therefore, the mounting collar 60 is prevented from distending outwardly in a radial direction when the feeding bottle is assembled.

The resilience of the mounting collar 60 acting on the corresponding helical threads 37, 46 acts as a locking force to maintain the fastening ring 40 and bottle 30 in position relative to each other.

A further engaging force applied to the fastening ring 40 and bottle 30 causes a compressive force to be applied to the mounting collar 60. That is, the mounting collar 60 is compressed between the mounting collar urging surface 47 of the fastening ring 40 and the upper face 34 of the bottle 30. As the mounting collar 60 is compressed between the fastening ring 40 and the upper face 34 of the bottle, the deformable material of the mounting collar 60 is urged to deform. More specifically, in the present arrangement, the region of increased wall thickness 67 is compressed and urged to deform inwardly. As mentioned above, the deformable material of the mounting collar 60 is restricted from distending outwardly due to the end face 64 of the mounting collar 60 locating against the inner surface 43 of the fastening ring 40.

When the mounting collar 60 is in its undeformed state, such as prior to assembly, the air valve 70 is in an open condition. Therefore, an open air path is defined through the air valve 70. When the feeding bottle 10 is assembled, the mounting collar 60 is compressed between the fastening ring 40 and the upper face 34 of the bottle 30, and material of the mounting collar 60 is urged to deform. The deformation occurs in an inwardly radial direction. As the air valve 70 is radially inside the region of increased wall thickness 67, an urging force is applied to the air valve 70 to urge the air valve to move between its open condition and its closed condition. The deformation of the region of increased wall thickness 67 causes one side of the air valve 70 to be urged towards the opposing side of the air valve 70. Further compression of the region of increased wall thickness 67 will increase the urging force applied to the air valve 70. Therefore, the air valve 70 will be urged into a further closed position. That is, the opening force required to allow air to be drawn through the air valve 70 will be increased. Leakage through the air valve 70 of liquid in the bottle 30 is therefore prevented.

In the event that leakage does occur, the fastening ring 40 is further rotated to increase the compressive force applied to the mounting collar 60. This increased force causes further deformation of the mounting collar 60 in an inwardly radial direction and acts on the air valve 70 to urge the air valve 70 into the closed or further closed condition. Furthermore, the opening force of the air valve 70 may be controlled by the user by adjusting the position of the fastening ring 40.

As the elongate opening 71 of the air valve 70 extends tangentially to the radial line of the mounting collar 60, deformation of material of the mounting collar 60 in an inwardly radial direction causes closure or further closure of the air valve 70. Invoked stresses in the material due to circumferentially-acting forces applied in response to the fastening ring 40 and the bottle 30 being rotated relative to each other act will act in the direction of the elongate opening 71 of the air valve 70 and so will not urge the air valve 70 to deform into an open condition. Therefore, leakage of the air valve 70 is further restricted. The circumferentially-acting forces may cause the air valve 70 to further close due to acting along the direction of the elongate opening 71.

When a vacuum is formed in the bottle 30 due to suction on the teat by an infant, the air valve 70 is urged to open due to pressure difference across the air valve 70. Therefore, the vacuum in the bottle 30 can be released. This helps to reduce baby colic.

When the feeding bottle 10 is disassembled, the compressive force applied to the mounting collar 60 is released, and so the air valve 70 is able to move into its undeformed state. Therefore, the air valve 70 is urged to return to its open condition due to the resilience of the mounting collar 60. This means that the air valve 70 is easier to clean. Furthermore, the air valve 70 is restricted from becoming stuck in its closed condition.

Although the air valve 70 is described as being in an open condition when the teat, acting as a mouthpiece, is in its undeformed state, it will be understood that in some embodiments the air valve 70 is in a closed condition in its undeformed state and will therefore be urged into a further closed condition. That is, the opening force required to allow the flow of air therethrough will be increased.

In the above described embodiments, the mouthpiece is a teat. However, it will be understood that alternative embodiments are envisaged. For example, the mouthpiece may be a spout. Referring now to FIG. 5, a spout 80 for the feeding bottle is shown. The arrangement of the feeding bottle is generally the same as described above including the container and fastening ring. However, the teat 20 is replaced by the spout 80. The fastening ring is mountable to the container to mount the spout 80 to the container. Therefore, a detailed description will be omitted herein.

The spout 80 acts as a mouthpiece for the feeding bottle. The spout 80 has a mouth portion 90 and a mounting collar 100. The mouth portion 90 is offset from a longitudinal axis of the mounting collar 100. The spout 80 has an air valve 110. The air valve 110 extends through the mounting collar 100 of the spout 80. The air valve 110 is a one-way valve. In the present arrangement, the air valve 110 is a duckbill valve.

The air valve 110 has an elongate opening 111. The elongate opening 111 extends perpendicular to a radial line of the spout 80, in particular the mounting collar 100. In the present embodiment, an outlet 113 of the air valve 110 is a slit. Operation and arrangement of the air valve 110 of the spout 80 shown in FIG. 5 is generally the same as operation and arrangement of the air valve 70 of the teat 20 described above and shown in FIGS. 1 to 4, and so a detailed embodiment will be omitted.

In the above described embodiments, the receptacle is a bottle. However, it will be understood that the receptacle may take alternative forms.

Although in the above described embodiment, the whole mounting collar is resilient and so is deformable upon compression, it will understood that in another embodiment only part of the mounting collar is compressible. For example, in one embodiment the mounting collar comprises an upper rigid layer and a lower resilient layer including the air valve.

Although only one air valve is described in the above described embodiments, it will be understood that the teat, acting as a mouthpiece, may include two or more air valves.

Although in the above described embodiments the fastening ring, acting as a connector, is threadingly engaged to the bottle, acting as a receptacle, it will be understood that alternative arrangements are anticipated. For example, one or more clasps may be used. In such arrangements, at least a part of the mounting collar is configured to be compressed between the connector and the receptacle.

It will be appreciated that the term “comprising” does not exclude other elements or steps and that the indefinite article “a” or “an” does not exclude a plurality. A single processor may fulfil the functions of several items recited in the claims. The mere fact that certain measures are recited in mutually different dependent claims does not indicate that a combination of these measures cannot be used to an advantage. Any reference signs in the claims should not be construed as limiting the scope of the claims.

Although claims have been formulated in this application to particular combinations of features, it should be understood that the scope of the disclosure of the present invention also includes any novel features or any novel combinations of features disclosed herein either explicitly or implicitly or any generalisation thereof, whether or not it relates to the same invention as presently claimed in any claim and whether or not it mitigates any or all of the same technical problems as does the parent invention. The applicants hereby give notice that new claims may be formulated to such features and/or combinations of features during the prosecution of the present application or of any further application derived therefrom.

1. A mouthpiece for an infant feeding vessel comprising
a mounting collar configured to be received between a receptacle for holding fluid and a connector for mounting the mouthpiece to the receptacle when assembled, and
an air valve in the mounting collar to allow the flow of air into the receptacle when the mouthpiece is mounted to the receptacle,
wherein the air valve is biased towards an open condition in its unassembled state,
wherein at least part of the mounting collar is resilient and is configured to be received between the receptacle and the connector when assembled,
the at least part of the mounting collar that is resilient being deformable to act on the air valve to tend the air valve towards a closed or further closed condition when the at least part of the mounting collar that is resilient is compressed between the receptacle and the connector and in turn urged to deform in an inwardly radial direction of the mounting collar.

2. The mouthpiece according to claim 1, wherein the air valve has an elongate opening extending perpendicular or substantially perpendicular to a radial line of the mouthpiece.

3. The mouthpiece according to claim 1, wherein the air valve is a duckbill valve.

4. The mouthpiece according to claim 1, wherein the mounting collar is resilient.

5. The mouthpiece according to claim 1, wherein the at least part of the mounting collar that is resilient is formed from hyper-elastic rubber.

6. The mouthpiece according to claim 1, wherein the mouthpiece is a teat for a feeding bottle.

7. The mouthpiece according to claim 1, wherein the mouthpiece is a spout for a toddler feeding cup.

8. An infant feeding vessel comprising a receptacle for receiving fluid, a mouthpiece according to claim 1 and a connector configured to mount the mouthpiece to the receptacle.

9. The infant feeding vessel according to claim 8, wherein the connector is configured to restrict the at least part of the mounting collar that is resilient from distending radially outwardly when the at least part of the mounting collar that is resilient is compressed between the receptacle and the connector.

10. The infant feeding vessel according to claim 8, wherein the receptacle has an upper end and the connector has an inner side, wherein the mounting collar is configured to be received between the upper end of the receptacle and the inner side of the connector during assembly of the infant feeding vessel.

11. The infant feeding vessel according to claim 10, wherein the profile of the mounting collar corresponds to the profile of a mounting collar receiving space defined between the upper end of the receptacle and the inner side of the connector during assembly of the infant feeding vessel.

12. The infant feeding vessel according to claim 1, wherein the connector is a fastening ring and, optionally, the connector is threadingly engagable with the receptacle.
